(19) United States
(12) Patent Application Publication
(10) Pub. No.: US 2004/0086099 A1
(43) Pub. Date: May 6, 2004

(54) Directory number conversion for private directory number plan

(75) Inventor: Irena Romanski, Egling (DE)

Correspondence Address: T. LESTER WALLACE, SILICON EDGE LAW GROUP LLP, 6601 KOII CENTER PKWY, STE 245, PLEASANTON, CA, 94566, US

(73) Assignee: Siemens Aktiengesellschaft

(21) Appl. No.: 10/286,318

(22) Filed: Nov. 1, 2002

(51) Int. Cl. H04M 3/42

(52) U.S. Cl. 379/201.01

(57) ABSTRACT

A method extracts an internal access code from the signaling of a connection between a first subscriber on a first switching center and a second subscriber on a second switching center in the public telephone network. The signaling from the first subscriber is converted to the corresponding internal access code of the first subscriber using a conversion table that contains the internal access codes of the corresponding signaling of the subscribers on the first switching center. The internal access code of the first subscriber is then communicated to the second subscriber allowing the second subscriber to call back the first subscriber.

### CROSS REFERENCE TO RELATED APPLICATIONS

This application is filed under 35 U.S.C. §111(a) and is based on and hereby claims priority under 35 U.S.C. §120 and §365 from International Application No. PCT/DE01/01652, filed on May 2, 2001 and published as WO 01/84860 on Nov. 8, 2001, which in turn claims priority from German Application No. 100 21 736.2, filed on May 4, 2000. International Application No. PCT/DE01/01652 was pending as of the filing date of this application. The United States was an elected state in International Application No. PCT/DE01/01652. This application claims the benefit under 35 U.S.C. §119 from German Application No. 100 21 736.2, filed on May 4, 2000, in Germany. The disclosure of each of the foregoing documents is incorporated herein by reference.

### TECHNICAL FIELD

The present invention relates to setting up telecommunications connections over a plurality of telephone terminals. More specifically, the invention relates to signaling a number to a telephone terminal on a different switching center that can be used to call back.

### BACKGROUND

In the public telephone network, international public telecommunication numbers are available for routing calls. These telephone numbers are shown to subscribers as the number on the public network termination point. This routing functionality enables a subscriber or a telecommunications operator to control the destination of a call in a flexible manner, depending on parameters that he defines, such as the time of a call or the region from which a call originates. Throughout the world, the coding of numbers for telephone terminals in the public telephone network is carried out in accordance with ITU-T Recommendation E.164.

Access to a virtual private network is a service available through the public telephone network. A virtual private network is a virtual direct-dialing network that is established within the existing public direct-dialing network through telephone number conversion in the switching centers of the public network.

FIG. 1 (prior art) shows a virtual private network 2 within the public telephone network 1. In addition to a subscriber's public telecommunication number, each subscriber in the virtual private network is allocated an intercom telephone number (a short-dialing number). During the setup of a connection, each intercom telephone number is converted into the public telecommunication number of the telephone terminal to which each private network subscriber is connected.

For subscribers both within the virtual private network and external to it, all telephones, facsimile machines and data stations in the virtual private network appear to be connected to a single switching center. An administrator can create an intercom telephone numbering plan that is appropriate for his subscriber group and that allows the networking of his private branch exchange to provide cost-effective communication for an organization having a large number of widely dispersed branches.

In the field of virtual private networks, such as in a Centrex solution (CENTRal office EXchange service), a prefix access code corresponding to the private network area from which a private call (intercom call) originates is communicated so that it can be used by the dialed subscriber to initiate a callback. Today, functioning intercom telephone numbering plans consist of sets of intercom telephone numbers that are unique throughout the virtual private network. When existing intercom telephone numbers are used, such as Centrex multi-address telephone numbers, numbers communicated along with the call are not sufficient to enable a call back because the prefix access code for the return direction is not made available. Until now, the separate switching center of a dialed subscriber does not have sufficient data to initiate a callback. Moreover, external subscribers, for example, subscribers on switching centers of different manufacturers as well as mobile radio subscribers, are not as yet included in intercom telephone numbering plans that have intercom telephone numbers that can be called back.

A method is therefore sought by which a calling subscriber can dial an intercom telephone number and thereby communicates an access code to a dialed subscriber on a separate switching center of a virtual private network enabling the dialed subscriber to call back. An apparatus is desired that communicates the access code from the calling subscriber on one switching center to the dialed subscriber in the public telephone network.

### SUMMARY

A method extracts an internal access code from the signaling of a telecommunications connection between a first subscriber on a first switching center and a second subscriber on a second switching center in the public telephone network. The signaling from the first subscriber is converted to the corresponding internal access code of the first subscriber using a conversion table that contains the internal access codes of the corresponding signaling of the subscribers on the first switching center. The internal access code of the first subscriber is then communicated to the second subscriber.

Even in varying configurations of intercom telephone numbering plans, the method generates intercom telephone numbers that can be called back. This also applies when using prefix access codes with intercom telephone numbers (short extension numbers). The method can be incorporated into existing network administration procedures and allows for sufficiently fast data access, for example, when using height-balanced directory number trees. The intercom telephone numbers used with prefix access codes in the method need not be unique throughout the network and thus allow for a high degree of flexibility. This is particularly attractive when an administrator wishes not to change existing intercom telephone numbering plans, for example, in a private branch exchange. This method also allows individual subscribers to be included in an intercom telephone numbering plan when those individual subscribers are mobile radio subscribers or are connected to a switching center of a different manufacturer. Despite the external basis of the numbering of such external subscribers, the generated intercom telephone number can be communicated to permit callback.

The intercom telephone number can in turn be used in the first switching center for feature control. Signaling of the internal number from the first switching center can in this case be interpreted as an internal call, so that the internal service feature interactions (for example Centrex) can be taken into account.

Other embodiments and advantages are described in the detailed description below. Also disclosed is an apparatus that converts the signaling from the first subscriber to the corresponding internal access code using a conversion table containing the internal access codes of the corresponding signaling of the subscribers on the first switching center. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a simplified schematic diagram of a virtual private network within the public telephone network.

FIG. 2 is a diagram of an example of an intercom telephone numbering plan using multi-address telephone numbers.

FIG. 3 is a diagram of the numbering for an intercom call between two switching centers.

FIG. 4 is a simplified schematic diagram a configuration of a telephone number converter.

FIG. 5 is diagram illustrating the generation of data for a telephone number converter.

FIG. 6 is a flowchart of a process of extracting an internal access code from a public telecommunications number to be used as a callback prefix.

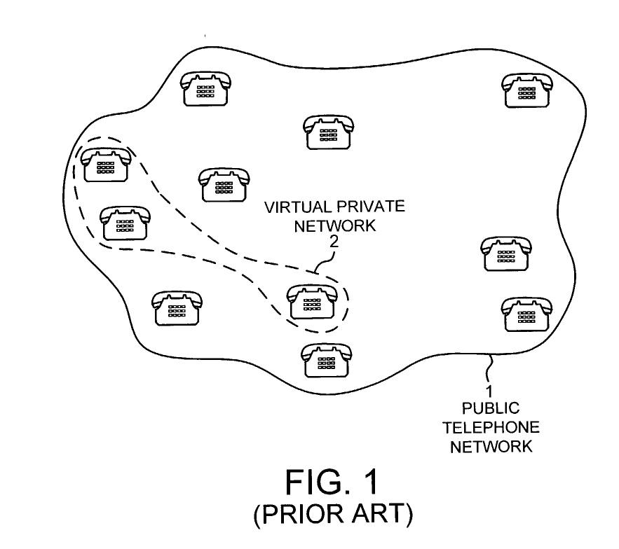

### DETAILED DESCRIPTION

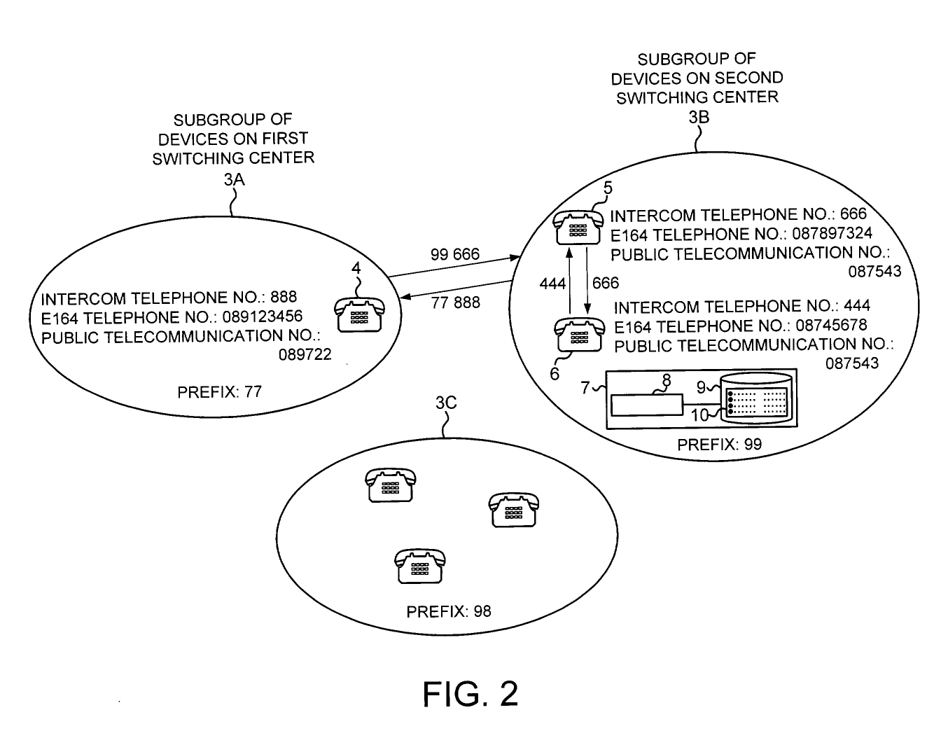

Reference will now be made in detail to some embodiments of the invention, examples of which are illustrated in the accompanying drawings. FIG. 2 illustrates one embodiment of the invention that is utilized in an intercom telephone numbering plan with multi-address telephone numbers.

The embodiment of FIG. 2 is used in a particularly advantageous manner with Centrex service, a supplementary service in private networks. Centrex service provides software emulation of a private branch exchange (PBX) within a public switching center. This virtual PBX provides subscribers, even in different locations, with telephone services having features similar to those of a PBX, for example, short dialing, patching in, automatic callback, call waiting, call forwarding, conference calling, caller ID and display charges. These features can be offered without a PBX or other similar device being physically present at the subscriber's location. The Centrex functionality is provided exclusively by the appropriate software modules and requires no hardware modification of the switching center. Moreover, virtual integration of mobile radio subscribers, such as GSM subscribers, into the Centrex numbering plan is feasible.

Individual devices, such as telephone terminals and office phone systems, can be organized into groups. FIG. 2 shows six devices organized into the subgroups 3A, 3B and 3C. Devices in subgroup 3A are connected through a first switching center, and devices in subgroup 3B are connected through a second switching center. In addition to a public telecommunication number for the subgroup, each of the devices also has an intercom telephone number (a short-dialing number). If a subscriber wishes to access members of the network-wide group, the subscriber dials the appropriate prefix access code (77, 99, 98, . . . ) followed by the intercom telephone number (888, 666, 444, . . . ) or the respective public telecommunication number. Thus, a first subscriber 4 can access a second subscriber 5 using either a public telecommunication number 087543 or an intercom telephone number 666. To use the intercom telephone number, the first subscriber 4 first dials the prefix 99 for the subgroup 3B and then the intercom telephone number 666. Second subscriber 5 in FIG. 2 can also access a third subscriber 6 using either an intercom telephone number 444 or a public telecommunications number 087543.

FIG. 2 also shows a telephone number converter 7 located within the subgroup of devices on the second switching center. In one embodiment, the telephone number converter 7 is incorporated into the second switching center. The telephone number converter 7 is comprised of a computer 8 and a database 9. Database 9 contains a telephone number conversion table 10. In this embodiment, a telephone number converter (not shown) similar to converter 7 is located within the subgroup 3A. The first subscriber 4 can use the telephone number converter in subgroup 3A to call back the second subscriber 5.

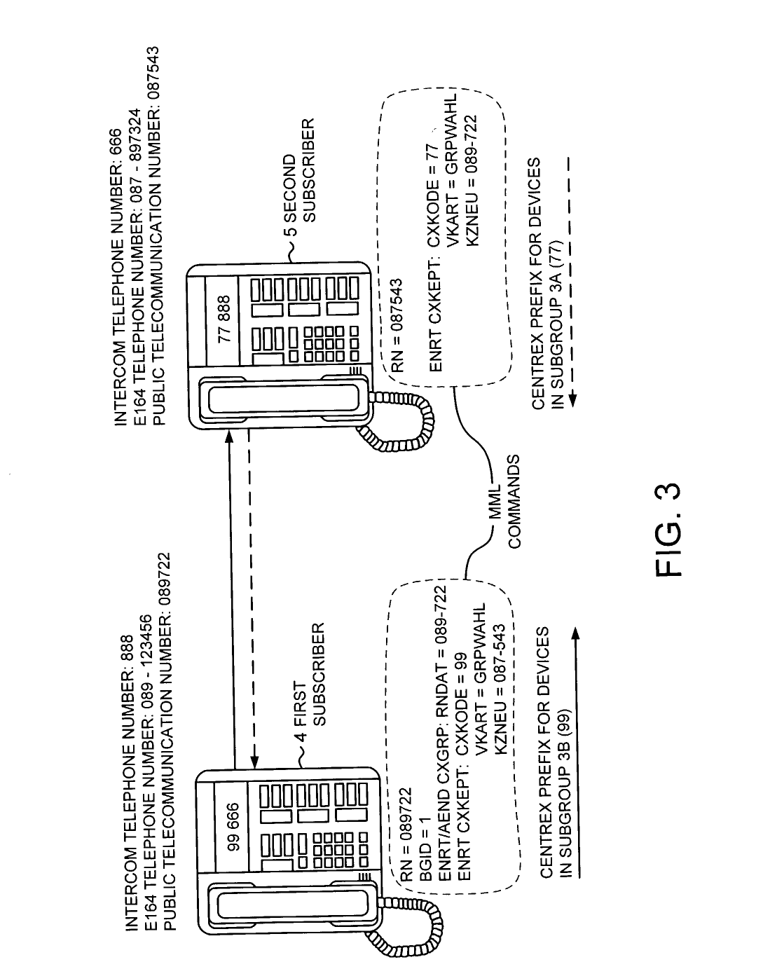

FIG. 3 illustrates a process by which numbers are communicated between telephone terminals to enable callback. The second subscriber 5 can call back the first subscriber 4 using the intercom telephone number if the intercom telephone number of the first subscriber 4 is communicated to the second subscriber 5. When using prefixes for subgroups, the intercom telephone numbering plan is not unique throughout the network. Thus, prefix access codes have not in the past been generated for the return direction. According to the embodiment, the callback intercom telephone number of the first subscriber 4 is extracted from the public telecommunication number of the first subscriber 4 by reverse translation. The extraction relies on the public telecommunication number of the first subscriber 4 being signaled to the second subscriber 5. This signaling is an interchange of control information of subscribers on the network and can be accomplished by overwriting the telephone number of the first subscriber 4 in the ISUP (ISDN User Part) or in the QSIP container (signaling over Q reference point). The public telecommunication number of a subscriber in subgroup 3A is used in a telephone number converter in subgroup 3B as a search criterion for the access code of the subscriber in subgroup 3A. FIG. 3 also shows how prefix access codes are set up. Commands in man-machine language (MML) can be used to set up the prefix access codes.

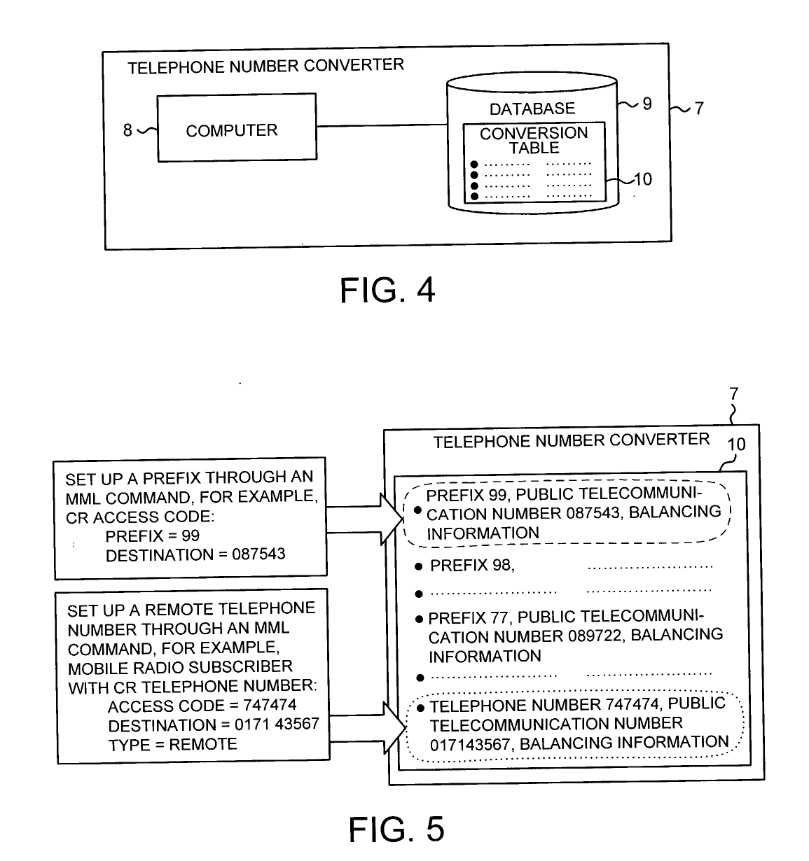

FIG. 4 shows the configuration of telephone number converter 7 in more detail. The telephone number converter 7 is comprised of a computer 8 and a database 9. Database 9 contains a telephone number conversion table 10. The conversion table 10 associates specific signaling with the appropriate internal access code. The conversion table 10 contains associated sets of numbers, each set containing a public telecommunication number and the prefix access code of the subgroup to which the public telecommunication number belongs. The computer 8 searches the database 9 on the basis of the signaled public telecommunication number for the callback intercom telephone number of subscriber 4 in subgroup 3A. As this dynamic search is time critical, the conversion table 10 can be stored as a height-balanced tree of telephone numbers. The telephone number conversion table 10 is generated through the normal administration of prefix access codes for routing purposes.

FIG. 5 shows the generation of the data for telephone number conversion, based on the example of the second subscriber 5. The process of generating the data takes place in the switching center for subscriber 5 at the same time that the prefixes (77, 98, . . . ) are set up. The prefixes can be set up through a man-machine language (MML) command. In this example, the conversion table 10 can include data relating to subscribers outside of subgroup 3B, such as a remote subscriber on a switching center of a different manufacturer (shown encircled with dashes) or even a mobile radio subscriber on another intercom telephone numbering plan (shown encircled with dots).

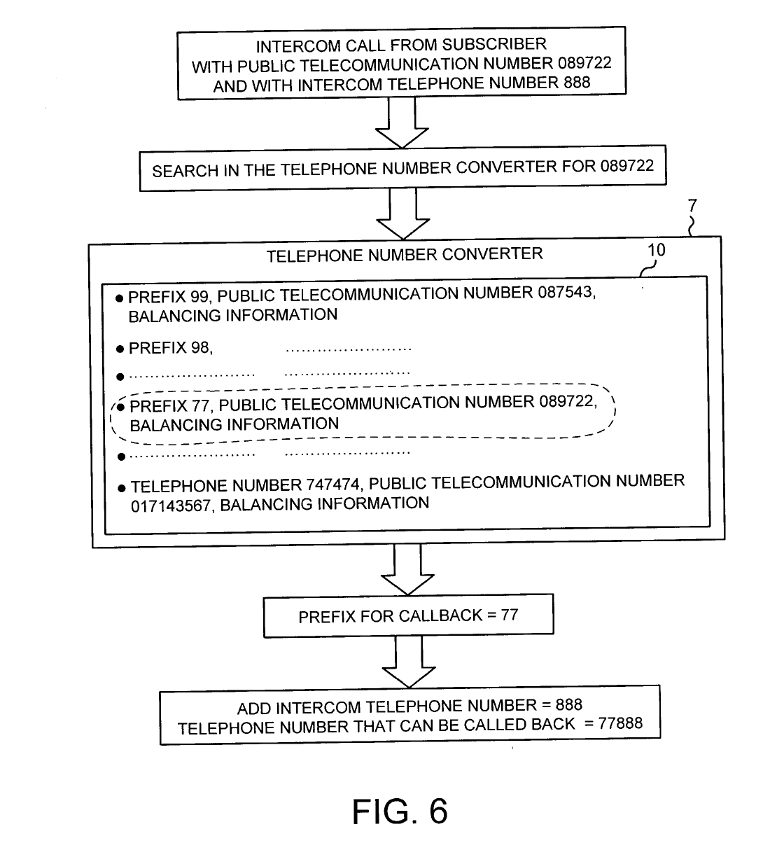

FIG. 6 shows a process for extracting an internal access code from a telephone number. Where the telephone number is a Centrex multi-address telephone number, subscriber 4 within the subgroup 3A signals its intercom telephone number 888. In the illustrated example where the telephone number is the number of a mobile radio subscriber, subscriber 4 within the subgroup 3A signals its public telecommunication number 089722. The appropriate telephone number that can be called back is generated in the telephone number converter 7. The telephone number converter 7 searches in the conversion table 10 for the internal access code corresponding to the public telecommunication number 089722, which is shown in FIG. 6 encircled with a dashed line. The internal access code is then displayed using existing means on the receiving telephone terminal as the telephone number of the calling subscriber.

In order for an intercom telephone number that can be called back to be displayed on the telephone terminal of subscriber 5, the telephone number converter 7 determines the appropriate callback prefix access code of subscriber 4. In this example of a Centrex multi-address telephone number, the prefix 77 must be dialed before dialing the intercom telephone number 888 in order to reach subscriber 4. The telephone number converter 7 can extract the internal access code, in this case the prefix 77, centrally in the switching center of the subgroup 3B or alternatively at the telephone terminal of subscriber 5.

Although the present invention has been described in connection with certain specific embodiments for instructional purposes, the present invention is not limited thereto. In one specific embodiment, for example, access codes are extracted from E.164 telephone numbers as opposed to from Centrex multi-address telephone numbers. Accordingly, various modifications, adaptations, and combinations of various features of the described embodiments can be practiced without departing from the scope of the invention as set forth in the claims.

What is claimed is:

1. A telephone number converter comprising:
a conversion table containing sets of numbers, each set including a public telecommunication number and an associated internal access code, wherein a first subscriber is on a first switching center and a second subscriber is located outside said first switching center, and wherein a first internal access code is associated with said first switching center; and
means for searching said conversion table to find a first public telecommunication number of said first subscriber and for indicating said first internal access code to said second subscriber.

2. The telephone number converter of claim 1, wherein said first internal access code is used by said second subscriber to call back said first subscriber.

3. The telephone number converter of claim 1, wherein said first internal access code is a prefix to an intercom telephone number for a Centrex service.

4. The telephone number converter of claim 1, wherein said first subscriber is a mobile radio subscriber.

5. The telephone number converter of claim 1, wherein said means for searching comprises a computer and a database.

6. The telephone number converter of claim 1, wherein each of said sets of numbers includes plural numbers each designating the same device.

7. The telephone number converter of claim 1, wherein each of said sets of numbers includes a telephone number conforming to ITU-T Recommendation E.164.

8. An apparatus for extracting an internal access code of a first subscriber on a first switching center from signaling sent from said first subscriber to a second subscriber, comprising:
a conversion table containing an internal access code corresponding to said signaling; and
a computer that converts said signaling to said internal access code in accordance with said conversion table, wherein said second subscriber is in the public telephone network outside of said first switching center.

9. The apparatus of claim 8, wherein said internal access code is a telephone number of said first subscriber that can be called back.

10. The apparatus of claim 8, wherein said first internal access code is a prefix to an intercom telephone number for a Centrex service.

11. The apparatus of claim 8, wherein said internal access code of said first subscriber is extracted centrally in a second switching center of said second subscriber.

12. The apparatus of claim 8, wherein said conversion table is stored in a height-balanced tree of telephone numbers.

13. The apparatus of claim 8, wherein said apparatus overwrites a telephone number in said signaling from said first subscriber that is specific to said first switching center.

14. A method for extracting an internal access code of a first subscriber on a first switching center from signaling sent from said first subscriber to a second subscriber, comprising:
converting said signaling to said internal access code using a conversion table, wherein said conversion table contains said internal access code in a corresponding relationship to said signaling, and wherein said second subscriber is in the public telephone network outside of said first switching center.

15. The method of claim 14, wherein said internal access code is a telephone number of said first subscriber that can be called back.

16. The method of claim 14, wherein said first internal access code is a prefix to an intercom telephone number for a Centrex service.

17. The method of claim 14, wherein said internal access code of said first subscriber is extracted centrally in a second switching center of said second subscriber.

18. The method of claim 14, wherein said conversion table is stored in a height-balanced tree of telephone numbers.

19. The method of claim 14, wherein a telephone number in said signaling from said first subscriber that is specific to said first switching center has been overwritten.

20. The method of claim 14, further comprising:
displaying said internal access code to said second subscriber.
